(19) United States
(12) Patent Application Publication
(10) Pub. No.: US 2012/0158652 A1
(43) Pub. Date: Jun. 21, 2012

(54) SYSTEM AND METHOD FOR ENSURING CONSISTENCY IN RAID STORAGE ARRAY METADATA

(76) Inventors: Pavan Ps, Bangalore (IN); Mahmoud K. Jibbe, Wichita, KS (US); Vivek Prakash, Bangalore (IN); Madhukar Gunjan Chakhaiyar, Gaya (IN)

(21) Appl. No.: 12/968,297

(22) Filed: Dec. 15, 2010

(51) Int. Cl. G06F 17/30

(52) U.S. Cl. 707/621; 707/690; 707/E17.005

(57) ABSTRACT

A system and method for ensuring consistency in RAID storage array metadata is disclosed. In one embodiment, the RAID storage array metadata residing in one or more drives is consolidated onto a metadata base volume that is in sync with the current RAID storage array metadata. Further, a point-in-time (PIT) image of the consolidated RAID storage array metadata in the metadata base volume, a system configuration (SC) file, and customer support data (CSD) are obtained. The PIT image, the SC file and CSD can be obtained based on a predetermined time interval and/or upon a change on the RAID storage array metadata. Furthermore, a delta change between two substantially sequentially obtained PIT images, SC files and CSD are determined. In addition, a consistency check (CC) is performed on the RAID storage array metadata based on the determined delta change.

### FIELD OF TECHNOLOGY

Embodiments of the present subject matter relate to the field of redundant array of independent disks (RAID) storage array metadata. More particularly, embodiments of the present subject matter relate to ensuring consistency in RAID storage array metadata.

### BACKGROUND

In existing redundant array of independent disks (RAID) storage arrays, metadata information associated with storage array configuration is stored in a specific location in each drive in the RAID storage arrays. Typically, this metadata is not backed up and any corruptions and/or errors in the metadata cannot be restored. The metadata may get corrupted due to various scenarios, such as input/output (I/O) requests committed on the metadata due to corrupted pointers to actual location, writes on the metadata region due to bugs in the controller firmware, changes in configuration during the drive reconstruction that may cause an inconsistent metadata region and so on. This can be catastrophic as the RAID configuration details may be corrupted and/or lost.

### SUMMARY

System and method for ensuring consistency in redundant array of independent disks (RAID) storage array metadata is disclosed. According to one aspect of the present subject matter, the method includes consolidating RAID storage array metadata residing in one or more drives onto a metadata base volume that is in sync with current RAID storage array metadata. Further, a point-in-time (PIT) image of the consolidated RAID storage array metadata in the metadata base volume, a system configuration (SC) file, and customer support data (CSD) is obtained based on a predetermined time interval and/or upon a change on the RAID storage array metadata. Furthermore, a delta change between two substantially sequentially obtained PIT images, SC files and CSD is determined. In addition, a consistency check (CC) is performed on the RAID storage array metadata based on the determined delta change.

According to another aspect of the present subject matter, a non-transitory computer-readable storage medium, for ensuring consistency in the RAID storage array metadata, has instructions that, when executed by a computing device causes the computing device to perform the method described above.

According to yet another aspect of the present subject matter, the system for ensuring consistency in the RAID storage array metadata includes one or more host devices, a RAID storage array communicatively coupled to the one or more host devices, a metadata base volume to store the consolidated RAID storage array metadata, SC files and CSD. The metadata base volume is communicatively coupled to the RAID storage array. The system also includes a RAID controller firmware coupled to the RAID storage array and the metadata base volume.

Further, the RAID controller firmware includes a consistency ensuring module that consolidates the RAID storage array metadata residing in one or more drives onto the metadata base volume. The metadata base volume is in sync with current RAID storage array metadata. The consistency ensuring module also obtains a PIT image of the consolidated RAID storage array metadata in the metadata base volume, the SC file, and the CSD based on a predetermined time interval and/or upon a change on the RAID storage array metadata.

Furthermore, the consistency ensuring module determines a delta change between two substantially sequentially obtained PIT images, SC files and CSD. In addition, the consistency ensuring module performs a CC on the RAID storage array metadata based on the determined delta change.

The methods and systems disclosed herein may be implemented in any means for achieving various aspects, and other features will be apparent from the accompanying drawings and from the detailed description that follow.

### BRIEF DESCRIPTION OF THE DRAWINGS

Various embodiments are described herein with reference to the drawings, wherein:

FIG. 1 illustrates a storage area network (SAN) including a consistency system, according to one embodiment;

FIG. 2 illustrates segments of a drive in a redundant array of independent disks (RAID) storage array containing RAID storage array metadata segments and data segments, according to one embodiment;

FIG. 3 is a schematic view of the RAID storage array metadata corruption detection before committing any new updates onto the consolidated RAID storage array metadata, according to one embodiment;

FIG. 4 illustrates synchronous copying of consolidated RAID storage array metadata on to a local system storage device as well as a pluggable flash drive residing on a controller board, according to one embodiment;

FIG. 5 illustrates a method for ensuring consistency in the RAID storage array metadata, according to one embodiment;

FIG. 6 illustrates a flowchart of an algorithm used in ensuring consistency in the RAID storage array metadata, according to one embodiment; and

FIG. 7 illustrates ensuring consistency using point-in-time (PIT) images, system configuration (SC) files and customer support data (CSD), according to one embodiment.

The drawings described herein are for illustration purposes only and are not intended to limit the scope of the present disclosure in any way.

### DETAILED DESCRIPTION

System and method for ensuring consistency in redundant array of independent disks (RAID) storage array metadata is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

The terms “change” and “update” are used interchangeably throughout the document.

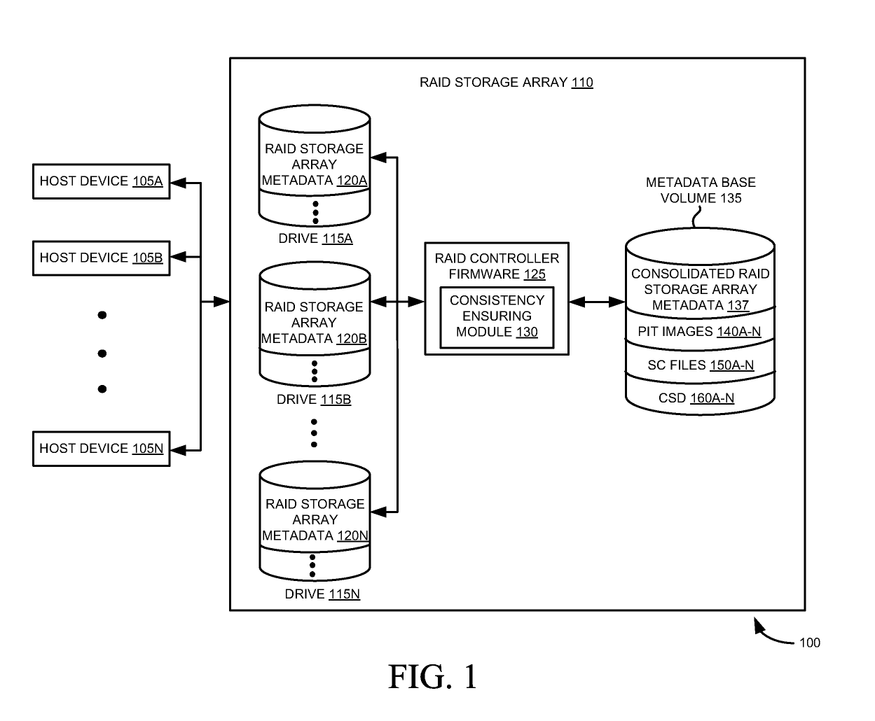

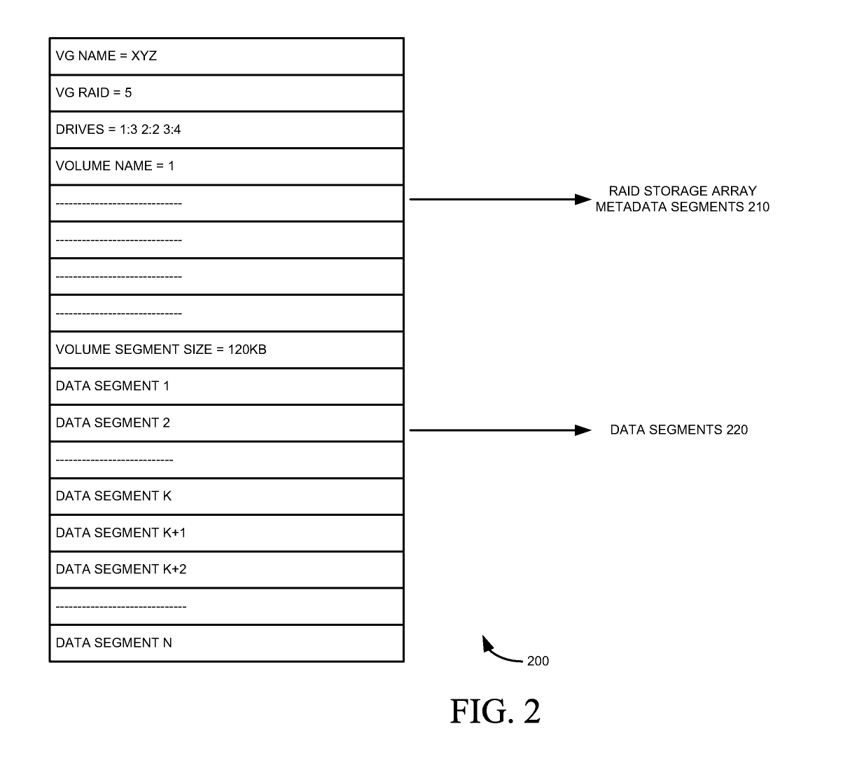

FIG. 1 illustrates a storage area network (SAN) 100 including a consistency system, according to one embodiment. Particularly, FIG. 1 illustrates one or more host devices 105A-N communicatively coupled to a RAID storage array 110. Further, the RAID storage array 110 includes one or more drives 115A-N, a RAID controller firmware 125 and a metadata base volume 135. Furthermore, each of the one or more drives 115A-N includes RAID storage array metadata 120A-N, respectively, which is explained in more detail with reference to FIG. 2. In addition, the RAID controller firmware 125 includes a consistency ensuring module 130. Also, the metadata base volume 135 includes consolidated RAID storage array metadata 137, point-in-time (PIT) images 140A-N, system configuration (SC) files 150A-N and customer support data (CSD) 160A-N that are communicatively coupled to the RAID controller firmware 125.

In operation, the one or more host devices 105A-N can modify the data in the one or more drives 115A-N or the configuration of the RAID storage array 110. Exemplary modifications to data include reading data, writing data, and so on. Exemplary modifications to the configuration of the RAID storage array 110 include creating a RAID volume, creating a logical drive, dynamically expanding volume of a drive and so on. Further, for every modification made by the one or more host devices 105A-N, the RAID storage array metadata 120A-N is updated.

In one embodiment, the consistency ensuring module 130 consolidates the RAID storage array metadata 120A-N and stores the consolidated RAID storage array metadata 137 in the metadata base volume 135. The consolidated RAID storage array metadata 137 is in sync with the current state of the RAID storage array metadata 120A-N. The consolidated RAID storage array metadata 137 is considered as a backup for the RAID storage array metadata 120A-N split across the one or more drives 115A-N which is combined and stored in the dedicated metadata base volume 135. In an example embodiment, the metadata information is stored in a centralized location in the RAID storage array 110. For example, the consistency ensuring module 130 ensures consistency of the RAID storage array metadata 120A-N in the SAN 100 and also controls and monitors the data stored in the RAID storage array 110.

Further in this embodiment, the consistency ensuring module 130 obtains PIT images 140A-N of the consolidated RAID storage array metadata 137, the SC files 150A-N and the CSD 160A-N. The PIT images 140A-N are read-only copies of the consolidated RAID storage array metadata 137 obtained at a point in time to avoid writing any updates to the consolidated RAID storage array metadata 137. Hence, preventing corruptions on the consolidated RAID storage array metadata 137. To further ensure the consistency of the RAID storage array metadata 120A-N and to enable debugging any inconsistencies, the SC files 150A-N and the CSD 160A-N are also obtained along with the PIT images 140A-N at the predetermined time interval and/or upon a change in the RAID storage array metadata 120A-N.

The SC files 150A-N includes the RAID storage array configuration information, such as a script to create volume groups using the one or more drives 115A-N, to create volumes, to map the volumes to the one or more host devices 105A-N and so on. Further, the CSD 160A-N includes the diagnostic logs from the RAID storage array components, core dumps associated with the RAID controller firmware 125, RAID storage array 110 recovery profiles, event logs and so on. The information in the SC files 150A-N and the CSD 160A-N enables to detect and debug any inconsistencies in the RAID storage array metadata 120 A-N. Further, the information in the SC files 150A-N and the CSD 160A-N assist to establish a consistency level of the RAID storage array configuration during a restore operation, when an inconsistency is detected on the RAID storage array metadata 120A-N.

In one embodiment, the PIT images 140A-N, the SC files 150A-N and the CSD 160A-N are obtained based on a predetermined time interval and/or upon a change in the RAID storage array metadata 120A-N. The term “change” here refers to a single metadata update to the RAID storage array metadata 120A-N. A limit to the maximum number of PIT images 140A-N can be defined by a user. Upon reaching the maximum defined limit, the first PIT image, for example the PIT image 140A is re-synced to the consolidated RAID storage array metadata 137. In another embodiment, to ensure security of the RAID storage array metadata information, the data in the consolidated RAID storage array metadata 137, the PIT images 140A-N, SC files 150A-N and CSD 160A-N are encrypted. This prevents any unauthorized access to the RAID storage array metadata information.

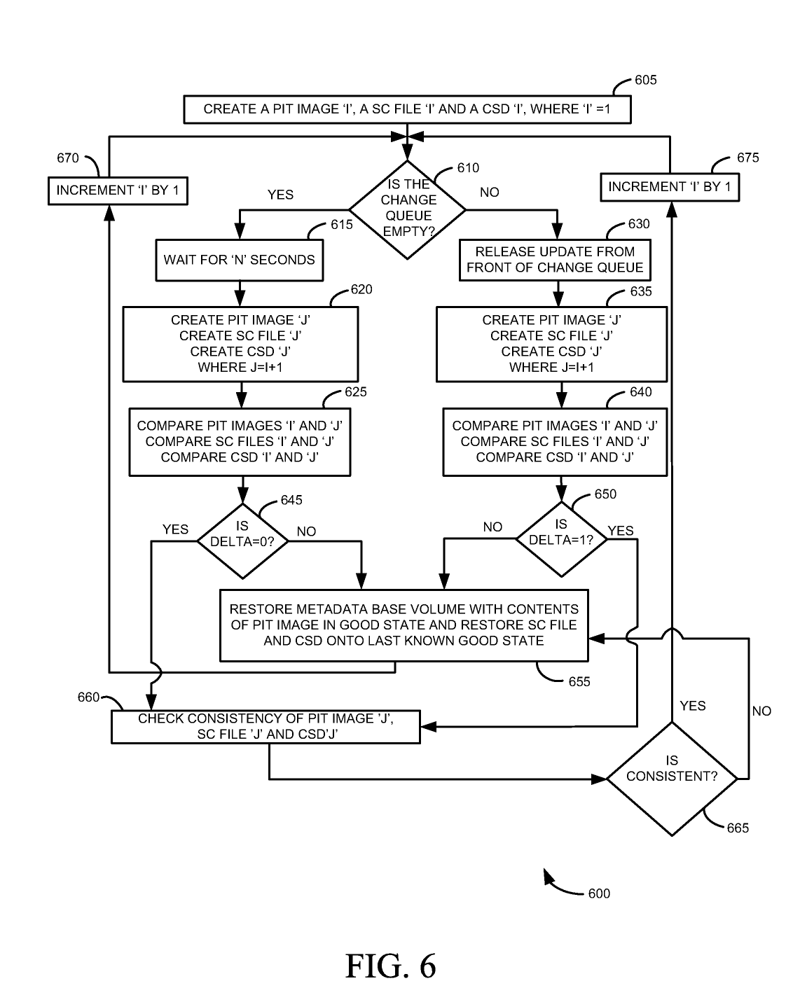

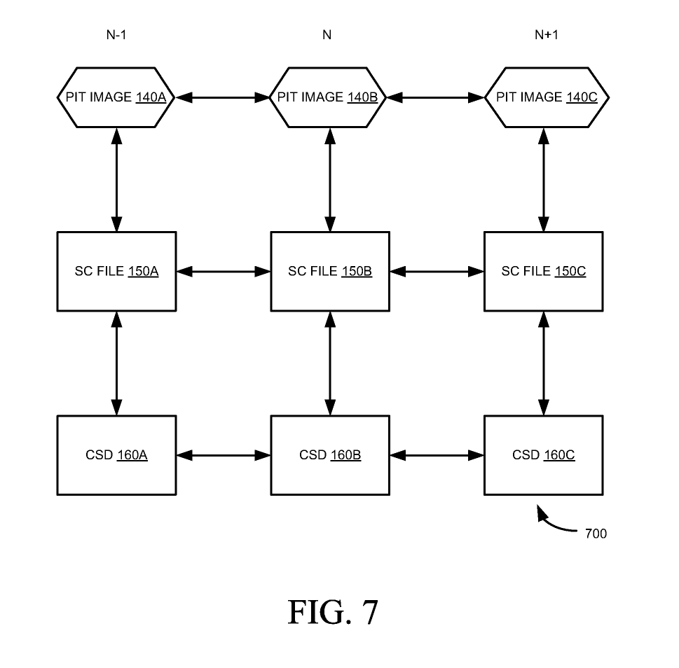

Further in this embodiment, the consistency ensuring module 130 determines a delta change between two substantially sequentially obtained PIT images 140A-N, SC files 150A-N and CSD 160A-N. For example, the delta change includes a value indicating the difference in data in the PIT images 140A-N, SC files 150A-N and CSD 160A-N obtained after a predetermined time interval and/or upon a change in the RAID storage array metadata 120A-N. Furthermore, the consistency ensuring module 130 performs a consistency check (CC) on the RAID storage array metadata 120A-N based on the determined delta change. This is explained in more detail with reference to FIGS. 6 and 7.

FIG. 2 illustrates segments of a drive in a RAID storage array 110, shown in FIG. 1, containing RAID storage array metadata segments 210 and data segments 220, according to one embodiment. For example, the RAID storage array metadata segments 210 include crucial information, such as RAID configuration of each drive 115A-N, a volume mapping, number of PITs obtained from each of the one or more drives 115A-N, number of logical drives in the one or more drives 115A-N, type of the drive used, such as data drive, a parity drive and the like, a RAID storage array network information, a RAID level of each logical drive group, storage capacity of the drive and so on. The data segments 220 include any data stored in the drive by the plurality of one or more host devices 105A-N (shown in FIG. 1).

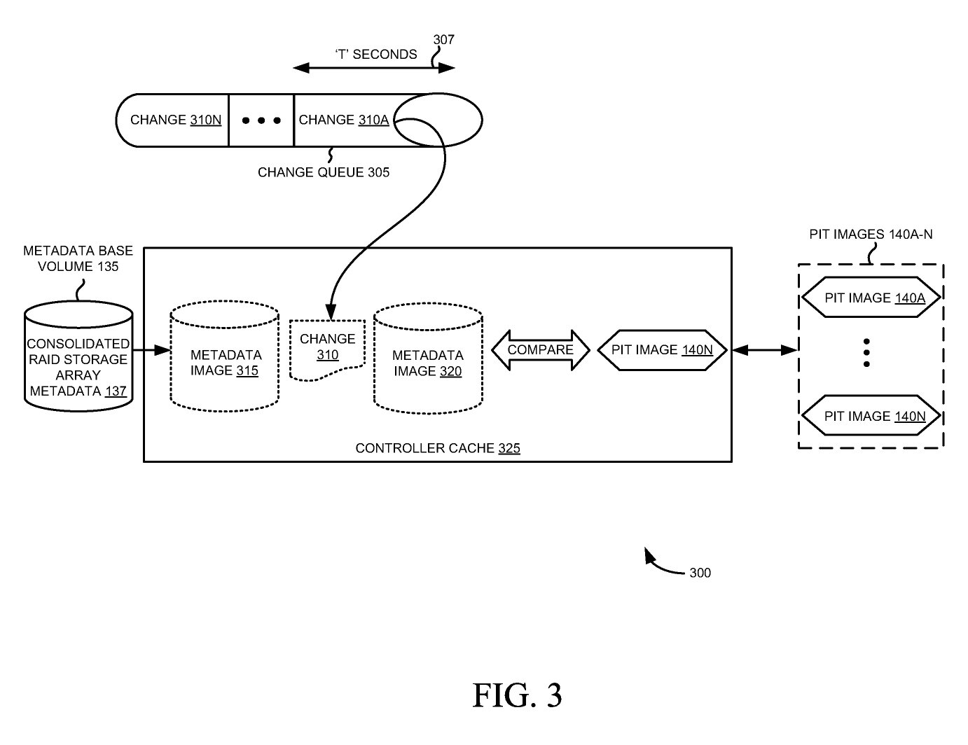

FIG. 3 is a schematic view 300 of the RAID storage array metadata 120A-N (shown in FIG. 1) corruption detection before committing any new updates onto the consolidated RAID storage array metadata 137, according to one embodiment. Particularly, FIG. 3 illustrates queuing the changes 310A-N to the RAID storage array metadata 120A-N in a change queue 305. The term “change” here refers to a single metadata update to the RAID storage array metadata 120A-N. In operation, whenever there is an update or multiple updates to the RAID storage array metadata 120A-N, the updates are queued in the change queue 305 so that a single update/change is considered at a time for detecting any corruptions before committing on the consolidated RAID storage array metadata 137. This process ensures that the change itself does not contain corruptions so that the metadata information is unaffected.

In one embodiment, a change 310 that occurred at ‘T’ seconds 307 is taken from the front of the change queue 305 into a controller cache 325. Further, the change 310 is embedded onto an image of the consolidated RAID storage array metadata 137 in the metadata base volume 135 i.e. metadata image 315, to create a metadata image 320. The metadata image 320 is then compared, by the consistency ensuring module 130, with a previously taken PIT image, for example, PIT image 140N. The comparison and corruption detection algorithm is explained in more detail with reference to FIG. 6. If no corruptions are detected the change 310 is committed on the consolidated RAID storage array metadata 137, otherwise, the change 310 is discarded.

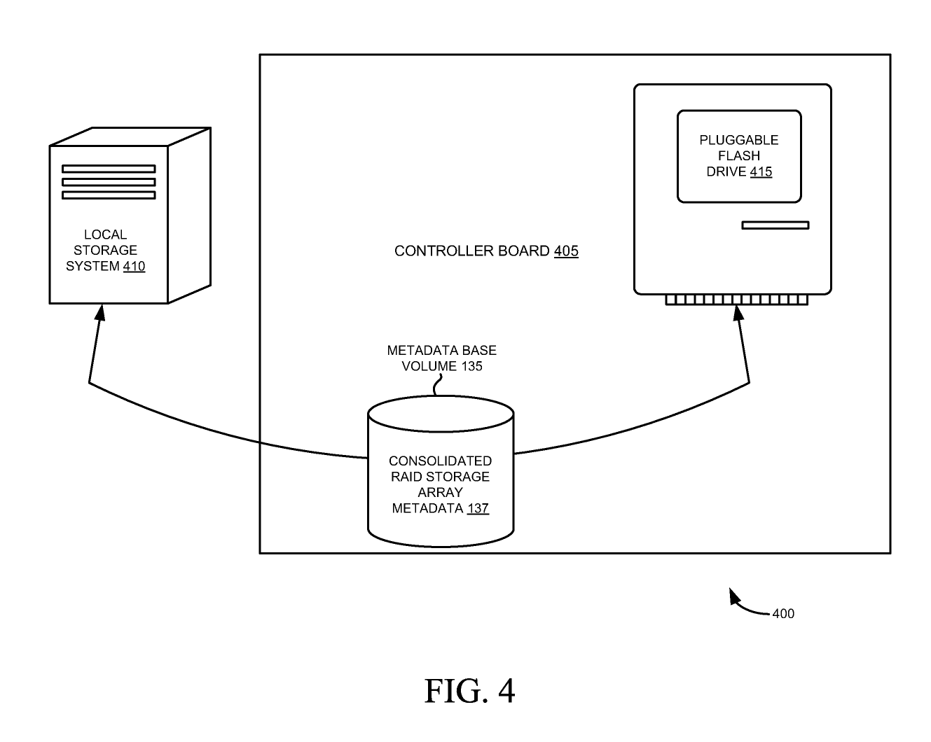

FIG. 4 illustrates a synchronous copying of consolidated RAID storage array metadata 137 on to a local storage system 410 as well as a pluggable flash drive 415 residing in a controller board 405, according to one embodiment. Particularly, FIG. 4 illustrates taking a backup of the consolidated RAID storage array metadata 137 in the metadata base volume 135. In one embodiment, the backup for the consolidated RAID storage array metadata 137 is taken, by the consistency ensuring module 130, on the pluggable flash drive 415 in the controller board 405. In this embodiment, the backup can also be taken on the local storage system 410. For example, the local storage system 410 is included in a host system for such backup purpose.

Further in this embodiment, the consistency ensuring module 130 synchronizes the updates on the consolidated RAID storage array metadata 137 to the pluggable flash drive 415 and the local storage system 410. Also in this embodiment, if the consistency ensuring module 130 detects any inconsistencies in the consolidated RAID storage array metadata 137, or if the consolidated RAID storage array metadata 137 drive fails or is lost, the contents, in good state, is restored from the pluggable flash drive 415 and/or the local storage system 410.

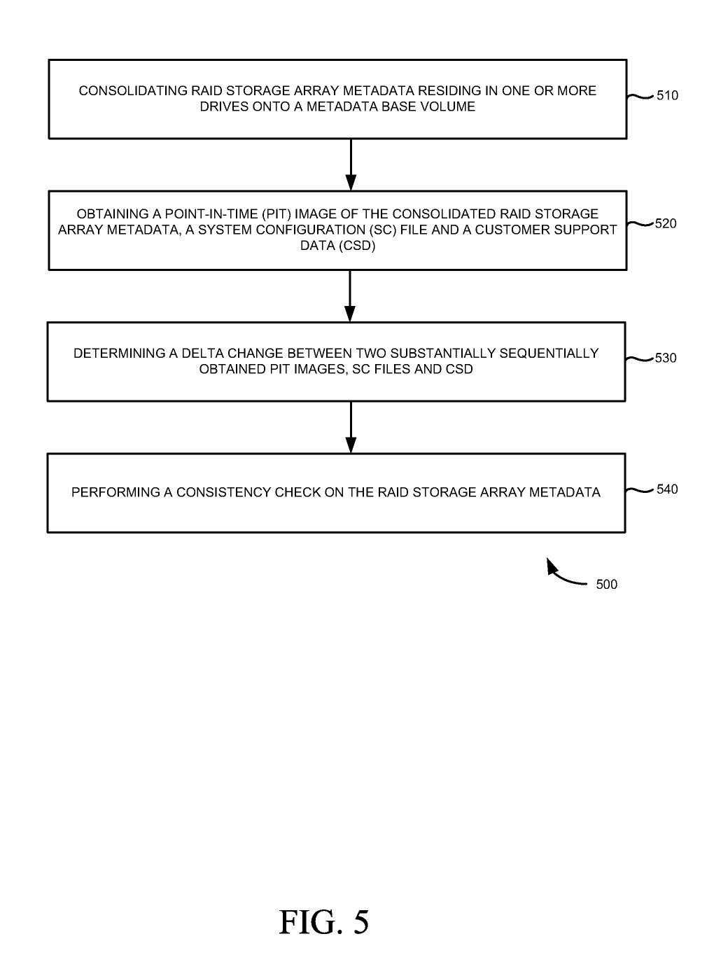

FIG. 5 illustrates a method for ensuring consistency in RAID storage array metadata, according to one embodiment. In block 510, the RAID storage array metadata residing in one or more drives is consolidated onto a metadata base volume. In one embodiment, the consolidated RAID storage array metadata is in sync with current RAID storage array metadata. In block 520, the PIT images of the consolidated RAID storage array metadata in the metadata base volume, the SC files and the CSD are obtained. In one embodiment, the PIT images, the SC files and the CSD are obtained based on a predetermined time interval and/or upon a change on the RAID storage array metadata. This is explained in more detail with reference to FIG. 1. Further, the change comprises a single metadata update to the RAID storage array metadata.

In block 530, a delta change between two substantially sequentially obtained PIT images, SC files and CSD is determined. In one embodiment, the delta change between two substantially sequentially obtained PIT images is determined, in the controller cache, before performing an update using the last PIT image on the metadata base volume. This is explained in greater detail with reference to FIG. 3. For example, this ensures the delta change between consecutive PIT images is always maintained at 1.

In block 540, a CC is performed on the RAID storage array metadata based on the delta change determined in block 530. In one embodiment, if no changes have occurred on the RAID storage array metadata and if the consistency ensuring module determines the delta change between the two substantially sequentially obtained PIT images, SC files and CSD are equal to 0, then the consistency ensuring module declares that the RAID storage array metadata is not corrupted. In such a scenario, the consistency ensuring module does not update the metadata base volume using the last PIT image.

In another embodiment, if a change has occurred on the RAID storage array metadata and if the consistency ensuring module determines the delta change between the two substantially sequentially obtained PIT images, SC files and CSD are equal to 1, then the consistency ensuring module declares that the RAID storage array metadata is not corrupted and, further does not update the metadata base volume using the last PIT image.

In yet another embodiment, if a change has not occurred on the RAID storage array metadata and if the consistency ensuring module determines the delta change between the two substantially sequentially obtained PIT images, SC files and CSD are not equal to 0, then the consistency ensuring module declares that the RAID storage array metadata is corrupted and further performs an update to the metadata base volume using the last consistent PIT image. Furthermore, the consistency ensuring module resynchronizes the metadata base volume with the RAID storage array metadata, SC files and CSD to keep them consistent.

In yet another embodiment, if a change has occurred on the RAID storage array metadata and if the consistency ensuring module determines the delta change between the two substantially sequentially obtained PIT images, SC files and CSD are equal to 0, then the consistency ensuring module declares that the RAID storage array metadata is corrupted and performs an update to the metadata base volume using the last consistent PIT image. Furthermore, the consistency ensuring module resynchronizes the metadata base volume with the RAID storage array metadata, SC files and CSD to keep them consistent. In addition, a copy of the consolidated RAID storage array metadata is synchronized onto the local storage system and/or the pluggable flash drive.

FIG. 6 illustrates a flowchart 600 of an algorithm used in ensuring consistency in the RAID storage array metadata, according to one embodiment. In block 605, a PIT image ‘I’, a SC file ‘I’ and a CSD ‘I’ of a value 1 is created. This block is similar to block 520 in FIG. 5. For example, the PIT image is created by the consistency ensuring module. In block 610, a check is made to determine whether the change queue is empty. For example, the change to the RAID storage array metadata is queued in the change queue, as explained in more detail with reference to FIG. 3.

If the change queue is empty, in block 615, the consistency ensuring module waits for ‘N’ seconds. In one embodiment, the consistency ensuring module waits for a predetermined time interval, say ‘N’ seconds, before creating a next PIT image. In block 620, a PIT image ‘J’, SC file ‘J’ and CSD ‘J’ are created, where J=I−1. Further, in block 625, the PIT image ‘I’, the SC file ‘I’ and the CSD ‘I’ are compared with the PIT image ‘J’, the SC file ‘J’ and the CSD ‘J’, respectively, which is explained in more detail with reference to FIG. 7.

In block 645, a check is made to determine whether the delta value of comparisons made in block 625 is equal to 0. The delta value refers to the difference between the PIT images ‘I’ and ‘J’, the SC files ‘I’ and ‘J’ and the CSD ‘I’ and ‘J’. If the delta value is not equal to 0, the process flow 600 performs the step in block 655. If the delta value is equal to 0, the process flow 600 performs the step in block 660.

Now referring back to block 610, if the change queue is not empty, in block 630, a single update is released from front of the change queue. In block 635, a PIT image ‘J’, SC file ‘J’ and CSD ‘J’ are created, where J=I+1. Further, in block 640, the PIT image ‘I’, the SC file ‘I’ and the CSD ‘I’ are compared with the PIT image ‘J’, the SC file ‘J’ and the CSD ‘J’, respectively, which is explained in more detail with reference to FIG. 7. For example, before committing the update on the RAID storage array metadata, the update is embedded onto a last PIT image, PIT image 140N, to check for any inconsistencies as explained in greater detail with reference to FIG. 3.

In block 650, a check is made to determine whether the delta value of comparisons made in block 640 is equal to 1. The delta value refers to the difference between the PIT images ‘I’ and ‘J’, the SC files ‘I’ and ‘J’ and the CSD ‘I’ and ‘J’. If the delta value is not equal to 1, the process flow 600 performs the step in block 655. If the delta value is equal to 1, the process flow 600 performs the step in block 660.

In block 655, metadata base volume is restored with content of PIT image in good state and SC file and CSD are restored onto last known good state. Further, in block 670, the value of ‘I’ is incremented by 1 and the process flow 600 is connected to block 610 as shown in FIG. 6.

Further, in block 660, consistency of PIT image ‘J’, SC file ‘J’ and CSD ‘J’ is checked, as explained in detail with reference to FIG. 7. In block 665, a check is made to determine whether the PIT image ‘J’, SC file ‘J’ and CSD ‘J’ are consistent. If the PIT image ‘J’, SC file ‘J’ and CSD ‘J’ are not consistent, the process flow 600 performs the step in block 655, as mentioned above. If the PIT image ‘J’, SC file ‘J’ and CSD ‘J’ are consistent, in block 675, the value of ‘I’ is incremented by 1 and the process flow 600 is connected to block 610 as shown in FIG. 6.

FIG. 7 illustrates ensuring consistency using PIT images 140A-N, SC files 150A-N and CSD 160A-N, according to one embodiment. Particularly, FIG. 7 illustrates comparing the PIT images 140A-C, the SC files 150A-C and the CSD 160A-C obtained at different time instants are compared. For example, the PIT image 140A, the SC file 150A and the CSD 160A can be obtained at N−1 second or when change ‘N−1’ has occurred on the RAID storage array metadata 120A-N. Further, the PIT image 140B, the SC file 150B and the CSD 160B can be obtained at Nth second or when the next change ‘N’ has occurred on the RAID storage array metadata 120A-N. Furthermore, the PIT image 140C, the SC file 150C and the CSD 160C can be obtained at N+1 second or when the next change ‘N+1’ has occurred on the RAID storage array metadata 120A-N.

In this embodiment, at N−1 second or at change ‘N−1’, the PIT image 140A, the file 150A and the CSD 160A are compared to determine whether the PIT image 140A is consistent with the SC file 150A and the CSD 160A. Further, at Nth second or at change ‘N’, the PIT image 140B, the SC file 150B and the CSD 160B are compared to determine whether the PIT image 140B is consistent with the SC file 150B and the CSD 160B. Furthermore, the PIT image 140A and the PIT image 140B, the SC file 150A and the SC file 150B and the CSD 160A and the CSD 160B are compared to determine a delta change. This is explained in more detail with reference to FIG. 6.

At N+1 second or at change ‘N+1’, the PIT image 140C, the SC file 150C and the CSD 160C are compared to determine whether the PIT image 140C is consistent with the SC file 150C and the CSD 160C. Further, the PIT image 140B and the PIT image 140C, the SC file 150B and the SC file 150C and the CSD 160B and the CSD 160C are compared to determine a delta change, as explained in more detail with reference to FIG. 6.

In various embodiments, the systems and methods described in FIGS. 1 through 7 improves consistency in the RAID storage array metadata 120A-N by detecting and correcting inconsistencies before and after the commitment of an update on the RAID storage array metadata 120A-N. Further, the systems and methods described in FIGS. 1 through 7 provide redundancy to the RAID storage array metadata 120A-N and thereby, reducing the risk of loss of metadata information.

Although the present embodiments have been described with reference to specific example embodiments, it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method for ensuring consistency in redundant array of independent disks (RAID) storage array metadata, comprising:
consolidating RAID storage array metadata residing in one or more drives onto a metadata base volume that is in sync with current RAID storage array metadata;
obtaining a point-in-time (PIT) image of the consolidated RAID storage array metadata in the metadata base volume, a system configuration (SC) file, and customer support data (CSD) based on a predetermined time interval and/or upon a change on the RAID storage array metadata;
determining a delta change between two substantially sequentially obtained PIT images, SC files and CSD; and
performing a consistency check (CC) on the RAID storage array metadata based on the determined delta change.

2. The method of claim 1, wherein the change comprises a single metadata update to the RAID storage array metadata.

3. The method of claim 1, further comprising:
if the determined delta change is equal to 0 and no changes have occurred on the RAID storage array metadata within the two substantially sequentially obtained PIT images, then declaring the RAID storage array metadata is not corrupted; and
not performing an update using a last PIT image on the metadata base volume.

4. The method of claim 1, further comprising:
if the determined delta change is equal to 1 and a change has occurred on the RAID storage array metadata within the two substantially sequentially obtained PIT images, then declaring the RAID storage array metadata is not corrupted; and
not performing an update using a last PIT image on the metadata base volume.

5. The method of claim 1, further comprising:
if the determined delta change is not equal to 0 and a change has not occurred on the RAID storage array metadata within the two substantially sequentially obtained PIT images, then declaring the RAID storage array metadata is corrupted; and
performing an update using a last PIT image on the metadata base volume to restore the consistent PIT image onto the RAID storage array metadata.

6. The method of claim 1, further comprising:
if the determined delta change is equal to 0 and a change has occurred on the RAID storage array metadata within the two substantially sequentially obtained PIT images, then declaring the RAID storage array metadata is corrupted; and
performing an update using a last PIT image on the metadata base volume to restore the consistent PIT image onto the RAID storage array metadata.

7. The method of claim 1, wherein determining the delta change between two substantially sequentially obtained PIT images, comprises:
determining the delta change between two substantially sequentially obtained PIT images in a controller cache before performing an update using a last PIT image on the metadata base volume.

8. The method of claim 1, further comprising:
synchronizing a copy of the consolidated RAID storage array metadata onto a local storage system and/or a pluggable flash drive.

9. A non-transitory computer-readable storage medium for ensuring consistency in redundant array of independent disks (RAID) storage array metadata, having instructions that, when executed by a computing device causes the computing device to:
consolidate RAID storage array metadata residing in one or more drives onto a metadata base volume that is in sync with current RAID storage array metadata;
obtain a point-in-time (PIT) image of the consolidated RAID storage array metadata in the metadata base volume, a system configuration (SC) file, and customer support data (CSD) based on a predetermined time interval and/or upon a change on the RAID storage array metadata;
determine a delta change between two substantially sequentially obtained PIT images, SC files and CSD; and
perform a consistency check (CC) on the RAID storage array metadata based on the determined delta change.

10. The non-transitory computer-readable storage medium of claim 9, wherein the change comprises a single metadata update to the RAID storage array metadata.

11. The non-transitory computer-readable storage medium of claim 9, further having instructions to:
determine if the delta change is equal to 0 and no changes have occurred on the RAID storage array metadata within the two substantially sequentially obtained PIT images, then declaring the RAID storage array metadata is not corrupted; and
not perform an update using a last PIT image on the metadata base volume.

12. The non-transitory computer-readable storage medium of claim 9, further having instructions to:
determine if the delta change is equal to 1 and a change has occurred on the RAID storage array metadata within the two substantially sequentially obtained PIT images, then declaring the RAID storage array metadata is not corrupted; and
not perform an update using a last PIT image on the metadata base volume.

13. The non-transitory computer-readable storage medium of claim 9, further having instructions to:
determine if the delta change is not equal to 0 and a change has not occurred on the RAID storage array metadata within the two substantially sequentially obtained PIT images, then declaring the RAID storage array metadata is corrupted; and
perform an update using a last PIT image on the metadata base volume to restore the consistent PIT image onto the RAID storage array metadata.

14. The non-transitory computer-readable storage medium of claim 9, further having instructions to:
determine if the delta change is equal to 0 and a change has occurred on the RAID storage array metadata within the two substantially sequentially obtained PIT images, then declaring the RAID storage array metadata is corrupted; and
perform an update using a last PIT image on the metadata base volume to restore the consistent PIT image onto the RAID storage array metadata.

15. The non-transitory computer-readable storage medium of claim 9, wherein determining the delta change between two substantially sequentially obtained PIT images, comprises:
determining the delta change between two substantially sequentially obtained PIT images in a controller cache before performing an update using a last PIT image on the metadata base volume.

16. The non-transitory computer-readable storage medium of claim 9, further having instructions to:
synchronize a copy of the consolidated RAID storage array metadata onto a local storage system and/or a pluggable flash drive.

17. A system for ensuring consistency in redundant array of independent disks (RAID) storage array metadata, comprising:
one or more host devices;
a RAID storage array communicatively coupled to the one or more host devices;
a metadata base volume, to store consolidated RAID storage array metadata, system configuration (SC) files and customer support data (CSD);
a RAID controller firmware coupled to the RAID storage array and the metadata base volume; and
a consistency ensuring module residing in the RAID controller firmware, wherein the consistency ensuring module consolidates RAID storage array metadata residing in one or more drives onto the metadata base volume that is in sync with current RAID storage array metadata, wherein the consistency ensuring module obtains a point-in-time (PIT) image of the consolidated RAID storage array metadata in the metadata base volume, SC file, and CSD based on a predetermined time interval and/or upon a change on the RAID storage array metadata, wherein the consistency ensuring module determines a delta change between two substantially sequentially obtained PIT images, SC files and CSD and wherein the consistency ensuring module performs a consistency check (CC) on the RAID storage array metadata based on the determined delta change.

18. The system of claim 17, wherein the change comprises a single metadata update to the RAID storage array metadata.

19. The system of claim 17, wherein the consistency ensuring module declares the RAID storage array metadata is not corrupted if the determined delta change is equal to 0 and no changes have occurred on the RAID storage array metadata within the two substantially sequentially obtained PIT images, and wherein the consistency ensuring module does not perform an update using a last PIT image on the metadata base volume.

20. The system of claim 17, wherein the consistency ensuring module declares the RAID storage array metadata is not corrupted if the determined delta change is equal to 1 and a change has occurred on the RAID storage array metadata within the two substantially sequentially obtained PIT images, and wherein the consistency ensuring module does not perform an update using a last PIT image on the metadata base volume.

21. The system of claim 17, wherein the consistency ensuring module declares the RAID storage array metadata is corrupted if the determined delta change is not equal to 0 and changes have not occurred on the RAID storage array metadata within the two substantially sequentially obtained PIT images, and wherein the consistency ensuring module performs an update using a last PIT image on the metadata base volume to restore the consistent PIT image onto the RAID storage array metadata.

22. The system of claim 17, wherein the consistency ensuring module declares the RAID storage array metadata is corrupted if the determined delta change is equal to 0 and a change has occurred on the RAID storage array metadata within the two substantially sequentially obtained PIT images, and wherein the consistency ensuring module performs an update using a last PIT image on the metadata base volume to restore the consistent PIT image onto the RAID storage array metadata.

23. The system of claim 17, wherein the consistency ensuring module determines the delta change between two substantially sequentially obtained PIT images on a controller cache before performing an update using a last PIT image on the metadata base volume.

24. The system of claim 17, wherein the consistency ensuring module synchronizes a copy of the consolidated RAID storage array metadata onto a local storage system and/or a pluggable flash drive.
